(19) United States
(12) Patent Application Publication
(10) Pub. No.: US 2010/0139788 A1
(43) Pub. Date: Jun. 10, 2010

(54) Metallic Air Admittance Valve

(76) Inventor: Derek J. Lackey, Macomb Township, MI (US)

Correspondence Address: GREGORY T. ZALECKI, 12900 HALL ROAD, SUITE 400, STERLING HEIGHTS, MI, 48313, US

(21) Appl. No.: 12/710,121

(22) Filed: Feb. 22, 2010

Related U.S. Application Data
(63) Continuation-in-part of application No. 10/908,004, filed on Apr. 25, 2005.

(51) Int. Cl. F16K 17/02

(52) U.S. Cl. 137/526

(57) ABSTRACT

A metallic air admittance valve has a tubular body with a valve chamber integral to one end of the tubular body. The valve chamber has a valve and an air inlet configured to permit the flow of air when the pressure within the valve is less than the pressure outside of the valve, but to prevent the flow of air when the pressure within the valve equals or exceeds the pressure outside of the valve. The tubular body and valve chamber are fabricated from metal and, therefore, do not emit noxious or toxic fumes when subjected to fire. Plumbing systems in commercial buildings may have metallic air admittance valves located within the plenum area of the building without presenting the risk of the distribution of toxic fumes throughout the building when the air admittance valve is subjected to fire.

This application is a continuation-in-part of U.S. patent application Ser. No. 10/908,004, filed on Apr. 25, 2005, now pending, and priority is claimed as to the filing date of application Ser. No. 10/908,004. Application Ser. No. 10/908,004, filed on Apr. 25, 2005, is incorporated herein by reference.

### BACKGROUND

Plumbing drain, waste and vent systems consist of drain pipes that provide a network for the removal of waste and vent pipes that prevent traps from siphoning. In a typical plumbing system traps are installed at every fixture. A trap is a U-shaped bend that is filled with water. The water in the trap prevents sewer gases from escaping through the fixture. A vent maintains the pressure between sewer gases and the atmosphere near the fixture. This permits water and waste to freely drain. The vent also prevents water from siphoning from a trap, thereby preventing the escape of sewer gases.

Traditional commercial and residential plumbing systems contain elaborate vent piping connected to each fixture. The vent piping adds a significant cost to new construction. It often makes retrofitting new fixtures into an existing structure expensive and difficult because of the need to route new vent pipes through existing walls and an existing roof. The use of air admittance valves partially solves this problem. An air admittance valve is essentially an air check valve. It is, however, more than simply an air check valve, as described below. It is usually attached near the trap of a fixture. It is a small device which is easy to install. It permits air to flow into a drain waste vent system, thereby preventing the siphoning of a trap, but does not permit sewer gas to escape. Thus, an air admittance valve has the potential to significantly reduce construction and remodeling costs because it does away with the need for much vent piping.

Air admittance valves are not universally accepted as a replacement for vent piping terminating outside of a building. The housing of currently available air admittance valves is plastic. The use of plastic air admittance valves in buildings can create safety problems when they are subjected to a fire. The valves are needed to often be installed in air plenum areas of buildings. An air plenum area of a building feeds the ventilating system of the building. When plastic is subjected to fire, noxious and toxic fumes result. Further, if an air admittance valve fails due to fire, sewer gases will enter the plenum. As a result of these potential problems, the use of plastic air admittance valves in the plenum areas of buildings is often legally prohibited or undesirable. What is needed is an air admittance valve which will not produce toxic fumes when subjected to fire and that is less likely to fail when subjected to fire.

One attempt to solve this problem appears within U.S. Pat. No. 6,799,600. There, a metal housing was provided which surrounds an installed plastic air admittance valve. A simpler and less costly approach to solving the problem is desirable.

### Definition of Air Admittance Valve

Air admittance valves (AAVs) are pressure-activated, one-way mechanical valves that are used in a plumbing drain, waste, and vent (DWV) system in place of conventional, through-the-roof, pipe venting. Normally closed, AAVs open when wastewater discharges, allowing air to circulate for proper drainage. When closed, AAVs prevent the escape of sewer gas and maintain the trap seal. Because AAVs can be located in any ventilated space, they eliminate the need for vent stack roof penetrations and can greatly reduce the length of vent lines. Due to these benefits, a plumbing system using AAVs usually costs less than conventional venting systems.

Although air admittance valves do function essentially as air check valves, the term has a more specific meaning in the plumbing and building industries. The term air admittance valve means more than simply a valve which admits air. The term “air admittance valve,” as used in the specification and claims herein means a
“one-way valve designed to allow air to enter the plumbing drainage system when negative pressures develop in the piping system. The device shall close by gravity and seal the vent terminal at zero differential pressure (no flow conditions) and under positive internal pressures. The purpose of an air admittance valve is to provide a method of allowing air to enter the plumbing drainage system without the use of a vent extended to open air and to prevent sewer gases from escaping into a building.”

This is the same definition used in Section 202 of the 2003 Michigan Plumbing Code. The Michigan Plumbing Code is derived from the International Plumbing Code (IPC). The 2006 IPC definition of an air admittance valve is the same as the Michigan Plumbing Code. There does, however, appear to be one typographical difference because the Michigan Code uses the terminology “valve designed to allow” while the IPC uses the terminology “valve design to allow.” This appears to be nothing more than the typographical transcription error from the IPC to the Michigan Code. The IPC has been adopted by a majority of the United States. The term “vent extended to open air” refers to a vent which exits on the exterior of a building to the atmosphere.

The National Standard Plumbing Code (NSPC) (Section E.8.1) similarly defines an air admittance valve as follows:
“Air admittance valve: A one way valve designed to allow air to enter the plumbing drainage system when negative pressures develop in the system. The device closes by gravity, without springs or other mechanical means, and seals the vent terminal at zero differential pressure (no flow conditions) and also under positive internal pressure. The purpose of an air admittance valve are (1) to provide a method of allowing air to enter the plumbing drainage system without the need for a vent extended outdoors to open air, and (2) to prevent sewer gases from escaping into the building.”

### SUMMARY

The present invention addresses these problems. Air admittance valves are commonly available. The typical current air admittance valve has a tubular body with a valve chamber integral to one end of the tubular body. The valve chamber contains a valve. The valve chamber has an air inlet. The valve permits the flow of air when air pressure outside of the valve is higher than air pressure within and on the other side of the valve. When the pressure differential is reversed air flow is prevented. Thus, when the air admittance valve is attached to a vent pipe of a plumbing system it will prevent high-pressure sewer gases from escaping into the atmosphere and will allow atmospheric pressure air to flow into the valve and prevent siphoning from trap water when the trap pressure is lowered by the flow of water. The tubular body and the valve chamber are typically one integral plastic part. Because the body and chamber of current air admittance valves are plastic, the air admittance valve is subject to the fire hazard risks referred to above.

This invention uses a tubular body and integral valve chamber which is fabricated from metal. Metal will not burn in a building fire. Metal does not give off noxious or toxic fumes when subjected to fire. Therefore, an air admittance valve having a metallic tubular body and integral valve chamber can be used in the plenum area of a building without a risk of toxic fumes being distributed through the building whenever the valve is subjected to fire. Further, the metallic tubular body and valve chamber provide much better protection from fire to the valve within the valve chamber. This lowers the risk of sewer gases escaping into a building during a fire. The preferred metals for the construction of the tubular body and valve chamber are copper, brass, black steel and cast iron. Many plumbing devices and pipes are constructed from copper, brass, black steel and cast iron. Therefore, the consistency of material will be maintained. Copper, brass, black steel and cast iron are resistive to corrosion. Copper, brass, black steel and cast iron are not expensive materials.

The metallic air admittance valve described herein is intended for use with any plumbing system having one or more waste water discharge devices. Such discharge devices include sinks, basins, tubs, water closets and urinals. The waste water discharge device is vented with a metallic air admittance valve.

### DRAWINGS

These and other features, aspects, and advantages of the present invention will become better understood with regard to the following description, appended claims, and accompanying drawings where:

FIG. 1 is a sectional view of a metallic air admittance valve inserted into a metallic vent pipe coupler. The position of the valve when trap pressure is lowered is shown in phantom.

FIG. 2 is a sectional view of a metallic air admittance valve inserted into a metallic vent pipe coupler showing air flow into the valve caused by reduced pressure within a trap.

FIG. 3 is a diagram of a plumbing system having multiple waste water discharge devices vented with metallic air admittance valves.

FIG. 4 is an enlarged view showing the air inlet, valve seat and valve of the metallic air admittance valve of FIG. 1.

FIG. 5 is an enlarged view of the metallic air admittance valve of FIG. 1 showing the mode of attachment between the metallic air admittance valve and the vent pipe coupler.

### DETAILED DESCRIPTION

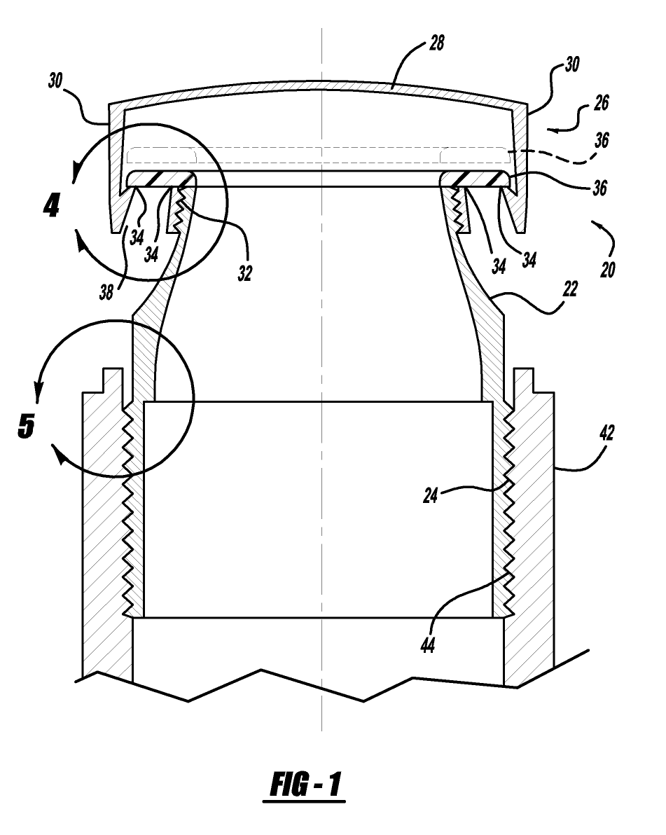

A preferred version of a metallic air admittance valve 20 is shown in FIGS. 1, 2, 4 and 5. The air admittance valve 20 has a tubular body 22. One end of the tubular body 22 has external threads 24. The external threads 24 are adapted to screw into a vent pipe coupler 42 or a vent pipe 54. The other end of the tubular body 22 has an integral valve chamber 26. The valve chamber 26 is comprised of a detachable top wall 28 having a circular perimeter, an inclined cylindrically shaped sidewall 30 attached to the top wall 28 and a valve seat 34. The sidewall 30 may contain internal threads 32 for connection with the upper end of the tubular body 22. If a threaded connection is used between the valve chamber 26 and the tubular body 22 the upper end of the tubular body 22 must be externally threaded.

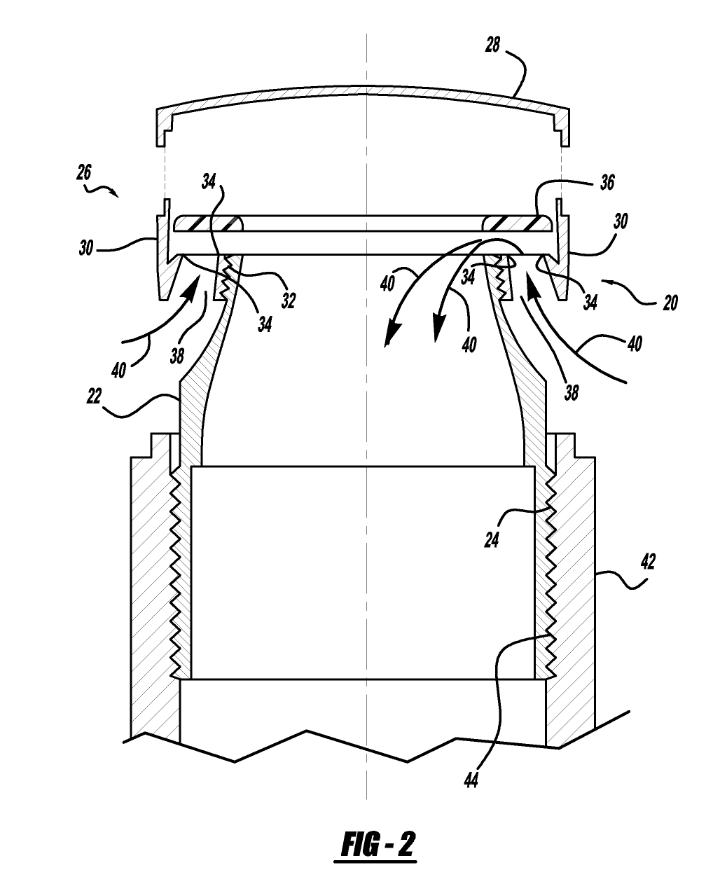

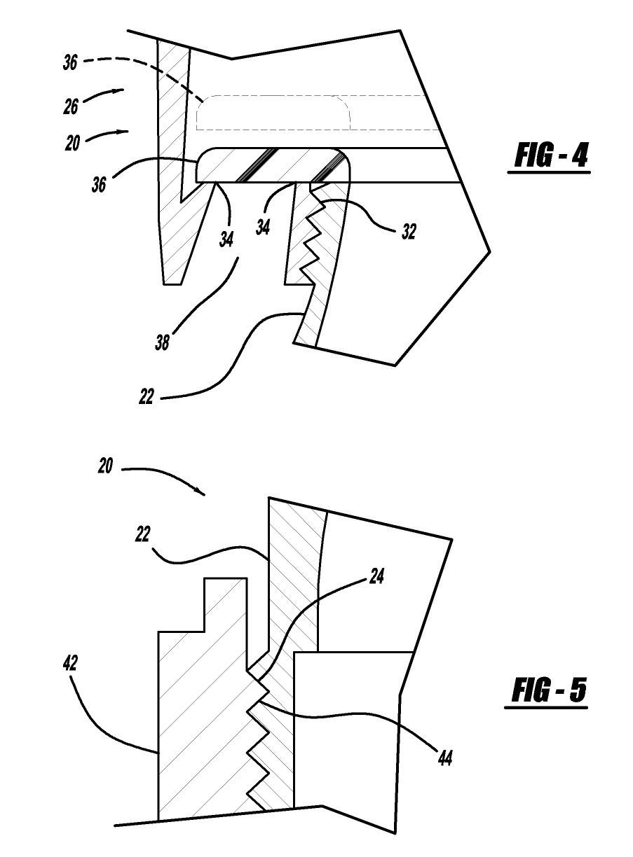

The valve seat 34 is in communication with an air inlet 38 formed into the valve chamber 26. A valve 36 regulates the flow of air 40 into and out of the tubular body 22. The valve 36, air inlet 38, tubular body 22 and valve chamber 26 are adapted to permit air to flow into the tubular body 22 when the pressure outside of the air admittance valve 20 exceeds the pressure within the tubular body, as shown in FIG. 2. The valve 36, air inlet 38, tubular body 22 and valve chamber 26 are also adapted to prevent the flow of air 40 when the pressure within the air admittance valve 20 equals or exceeds the pressure of the air 40 outside of the air admittance valve 20. FIG. 4 shows how the valve 36 seals the air inlet 38 to prevent the flow of air when the pressure within the air admittance valve 20 equals or exceeds the pressure of the air 40 outside of the air admittance valve 20.

The detachable top wall 28 facilitates the construction of the air admittance valve 20 by simplifying the ability to place the valve 36 during construction. The detachable top wall 28 also permits servicing and replacement of the valve 36 after installation. The incline of the inclined sidewalls 30 helps prevent the valve 36 from becoming jammed within the valve chamber 26. The valve chamber 26, including the top wall 28, may be combined with the tubular body 22 as one integral piece.

The valve chamber 26 and the tubular body 22 are fabricated from metal. This provides the fire resistant properties previously described. The preferred metals are copper, brass, black steel and cast iron. Many plumbing systems use copper, brass, black steel or cast iron pipes. When two plumbing parts are attached together it is desirable that they be constructed from the same type of metal to minimize the chemical reaction and future corrosion at the intersection of the parts. Many plumbing parts are also fabricated from brass because of its desirable appearance and corrosion resistant properties. For this reason an air admittance valve 20 having a brass tubular body 22 and a brass valve chamber 26 may be desired. Another benefit of using copper, brass, black steel or cast iron for the fabrication of the tubular body 22 and the valve chamber 26 is the reasonable cost and availability of these materials.

The external threads 24 of the lower end of the tubular body 22 may be directly screwed into an internally threaded vent pipe 54 if the vent pipe 54 is so configured. Often, however, the vent pipe 54 to which the air admittance valve 20 is to be attached does not have internal threads adapted to receive the external threads 24 of the lower end of the tubular body 22 of the air admittance valve 20. In this situation a vent pipe coupler 42 is used to attach the air admittance valve 20 to the vent pipe 54. The vent pipe coupler 42 has internal threads 44 at one end. The internal threads 44 are adapted to receive the external threads 24 of the lower end of the tubular body 22. The other end of the event pipe coupler 42 is adapted to sealingly fit onto the vent pipe 54. A number of ways to accomplish the sealing fit are commonly available, depending upon the configuration of the end of the vent pipe 54 to which the vent pipe coupler 42 is to be attached. The other end of the vent pipe coupler 42 may be adapted to attach to a vent pipe 54 by the use of threads (external or internal), a connecting boot or an enlarged flange.

The vent pipe coupler 42 is fabricated from metal. Therefore it provides the same fire resistant properties as provided by the metallic tubular body 22 and the metallic valve chamber 26. The preferred material for the fabrication of a vent pipe coupler 42 is copper, brass, black steel or cast iron for the same reasons that copper, brass, black steel and cast iron are desirable materials for the fabrication of the tubular body 22 and the valve chamber 26.

When the air admittance valve 20 is attached to a vent pipe 54 having a pressure higher than or equal to atmospheric pressure the valve 36 sits on the valve seat 34 and prevents the flow of air 40 through the air inlet 38, as shown in FIG. 1 and FIG. 4. When the pressure within the vent pipe 54 is lower than atmospheric pressure, such as when water flows through an attached trap, the valve 36 lifts off of the valve seat 34 and permits the flow of air 40, as shown in FIG. 2. This is also demonstrated by the phantom outline position of the valve 36 shown in FIG. 1 and FIG. 4.

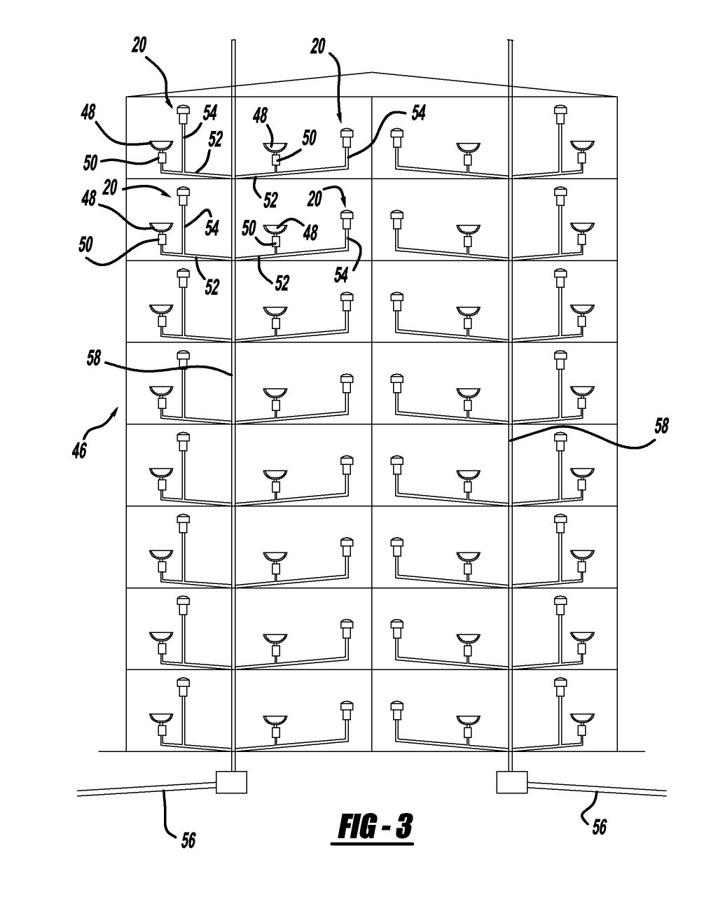

FIG. 3 shows a plumbing system 46 installed in a commercial building. The building has multiple wastewater discharge devices 48 on multiple floors. Such discharge devices 48 include sinks, basins, tubs, water closets and urinals. Each wastewater discharge device 48 has a trap 50. The traps 50 are generally filled with water which prevents the escape of sewer gases through the wastewater discharged devices 48. Trap pipes 52 connect the traps 50 to an external vent pipe 58. The external vent pipe 58 ultimately feeds waste and drain water into a waste pipe 56. One end of each vent pipe 54 is attached to a trap pipe 52. The other end of the vent pipe 54 is attached to a metallic air admittance valve 20, as described above. Such venting of the wastewater discharge devices 48 with air admittance valves 20 prevents the siphoning of water out of the trap 50 when water flows through the trap 50. Many times the air admittance valves 20 will be installed in the plenum area of a building. Since the air admittance valves 20 and any vent pipe couplers 42 used are fabricated from metal they will not contaminate the ventilating system of the building with noxious or toxic fumes when exposed to fire.

If the vent pipe 54 has threads configured to mate with the external threads 24 of the lower end of the tubular body 22, the lower end of the tubular body 22 is screwed into those threads in order to install the metallic air admittance valve 20. Otherwise, the metallic vent pipe coupler 42 is first attached to the vent pipe 54. Then the metallic air admittance valve 20 is screwed into the internal threads 44 located at the open end of the vent pipe coupler 42. Once installed, with or without a metallic vent pipe coupler 42, the metallic air admittance valve 20 will provide the functions of an air admittance valve, while avoiding the noxious and toxic fume risks presented by plastic air admittance valves which are subjected to fire.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. An air admittance valve having a tubular body with a valve chamber integral to one end of the tubular body, said air admittance valve being adapted to allow air to enter a plumbing drainage system when negative pressures develop in the system, said air admittance valve being adapted to close by gravity and seal at zero differential pressure and under positive internal pressures, whereby air may enter the plumbing drainage system of a plumbing drainage system vented with an air admittance valve without the use of a vent extended to open air and whereby sewer gases are prevented from escaping from said air admittance valve, said valve chamber having a valve and an air inlet, wherein the tubular body and the valve chamber are fabricated from metal.

2. The air admittance valve of claim 1, further comprising a metallic vent pipe coupler attached to the other end of the tubular body.

3. The air admittance valve of claim 1, wherein the tubular body and the valve chamber are fabricated from copper.

4. The air admittance valve of claim 1, wherein the tubular body and the valve chamber are fabricated from brass.

5. The air admittance valve of claim 1, wherein the tubular body and the valve chamber are fabricated from black steel.

6. The air admittance valve of claim 1, wherein the tubular body and the valve chamber are fabricated from cast iron.

7. The air admittance valve of claim 2, wherein the tubular body and the valve chamber are fabricated from copper.

8. The air admittance valve of claim 2, wherein the tubular body and the valve chamber are fabricated from brass.

9. The air admittance valve of claim 2, wherein the tubular body and the valve chamber are fabricated from black steel.

10. The air admittance valve of claim 2, wherein the tubular body and the valve chamber are fabricated from cast iron.

11. A plumbing system having one or more wastewater discharge devices vented with an air admittance valve having a tubular body with a valve chamber integral to one end of the tubular body, said air admittance valve being adapted to allow air to enter a plumbing drainage system when negative pressures develop in the system, said air admittance valve being adapted to close by gravity and seal at zero differential pressure and under positive internal pressures, whereby air may enter the plumbing drainage system of a plumbing drainage system vented with an air admittance valve without the use of a vent extended to open air and whereby sewer gases are prevented from escaping from said air admittance valve, said valve chamber having a valve and an air inlet, wherein the tubular body and the valve chamber are fabricated from metal.

12. The plumbing system of claim 11, further comprising a metallic vent pipe coupler attached to the other end of the tubular body.

13. The plumbing system of claim 11, wherein the tubular body and the valve chamber are fabricated from copper.

14. The plumbing system of claim 11, wherein the tubular body and the valve chamber are fabricated from brass.

15. The plumbing system of claim 11, wherein the tubular body and the valve chamber are fabricated from black steel.

16. The plumbing system of claim 11, wherein the tubular body and the valve chamber are fabricated from cast iron.

17. The plumbing system of claim 12, wherein the tubular body and the valve chamber are fabricated from copper.

18. The plumbing system of claim 12, wherein the tubular body and the valve chamber are fabricated from brass.

19. The plumbing system of claim 12, wherein the tubular body and the valve chamber are fabricated from black steel.

20. The plumbing system of claim 12, wherein the tubular body and the valve chamber are fabricated from cast iron.
